(19) United States
(12) Patent Application Publication
(10) Pub. No.: US 2026/0219514 A1
(43) Pub. Date: Jul. 30, 2026

(54) GLASSES WITH MAGNETIC HINGE ASSEMBLY

(71) Applicant: LUXOTTICA S.R.L., Agordo (BL) (IT)

(72) Inventor: Daniele PELLEGRINI, Belluno (BL) (IT)

(73) Assignee: LUXOTTICA S.R.L., Agordo (BL) (IT)

(21) Appl. No.: 19/141,834

(22) PCT Filed: Dec. 20, 2023
(86) PCT No.: PCT/IB2023/062987

§ 371 Date: Jun. 20, 2025

(30) Foreign Application Priority Data
Dec. 22, 2022 (IT) 102022000026565

(51) Int. Cl. G02C 5/22

(52) U.S. Cl. CPC G02C 5/2263; G02C 2200/02

(57) ABSTRACT

Glasses that include a front and two temples rotatably coupled to the front to rotate between a first stable opening position and a second stable closing position, and two hinge assemblies by which the temples are rotatably coupled to the front. Each of the hinge assemblies includes at least four first magnets applied on the front, the at least four first magnets are spaced apart from each other and arranged so as to describe a circumference. The at least four first magnets have free poles at alternating polarities according to any period, at least four second magnets applied to the respective temple, opposed to the at least four first magnets, the at least four second magnets are spaced apart from each other and arranged so as to describe a circumference.

### The present invention refers to glasses with magnetic hinge assembly.

Glasses also mean mask glasses such as for example ski mask glasses or work mask glasses and/or other known types of mask glasses.

As is known, the glasses comprise hinges which rotatably couple the temples to the front of the glasses frame.

Nowadays, there are different types of hinges for glasses, for example magnetic hinges.

Usually, the magnetic hinges available on the market comprise at least one first magnet coupled to the front of the glasses frame and at least one second magnet at inverted polarity with respect to the first coupled to the respective temple.

Such hinges allow to create a safe and reliable rotatable coupling between the front and the respective temple; furthermore, the magnets ensure a quick and easy maintenance of the hinge itself in case of breakage or damage, and of replacement of the respective temple in case of customizable glasses frame, for example selecting and coupling temples having different forms, materials, or colours, depending on the user requirements, to the front.

However, such magnetic hinges have the drawback of having a not very fluid movement during the rotation of the temples and being subjected to heavy wear.

An object of the present invention is to overcome the above-mentioned drawbacks and particularly that of ideating glasses with magnetic hinge assembly which have a fluid movement during the rotation of the temples and are subjected to a lower wear than that of the prior art.

These and other objects according to the present invention are achieved by creating glasses as set forth in claim 1.

Further features of the glasses are object of the dependent claims.

The features and advantages of the glasses according to the present invention will be more apparent from the following exemplary and non-limiting description, referred to the attached schematic drawings wherein:

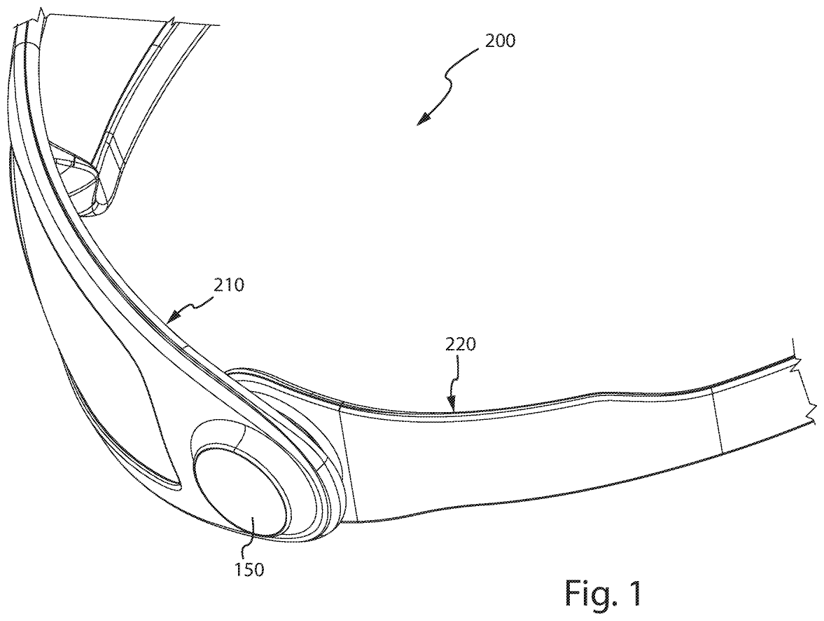

FIG. 1 is a perspective view of the glasses with magnetic hinge assembly according to a first embodiment of the present invention;

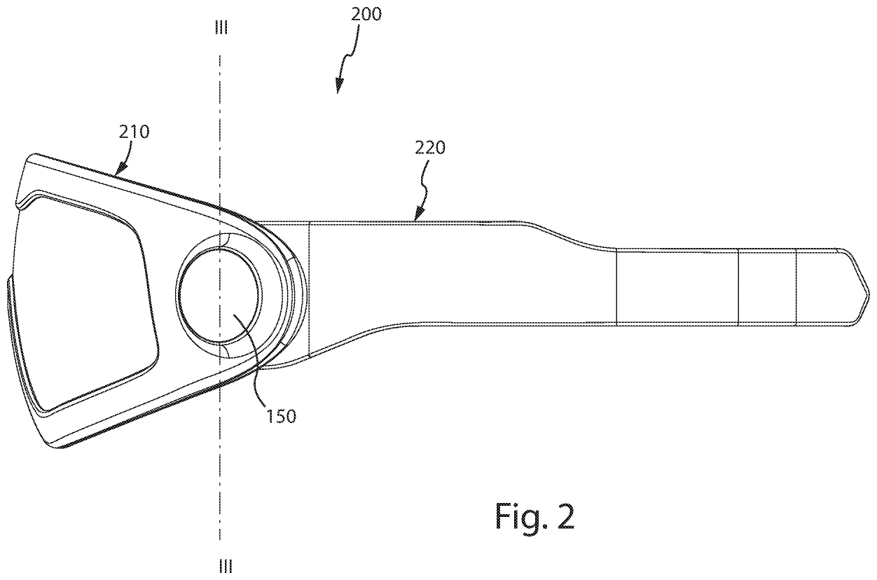

FIG. 2 is a side view of the glasses of FIG. 1 when the temples are in a first stable opening position;

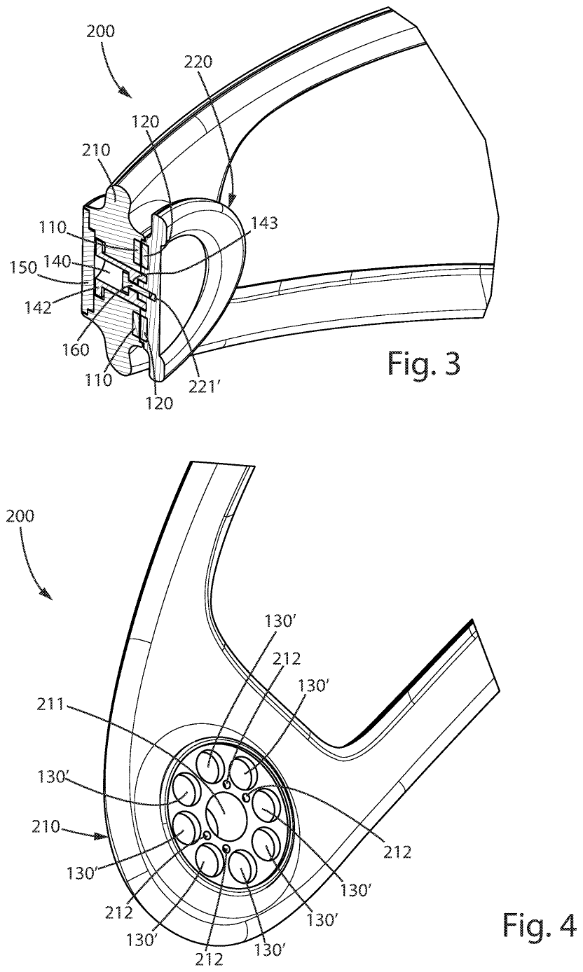

FIG. 3 is a sectional perspective view along the sectional line III-III of the glasses of FIG. 2;

FIG. 4 is a perspective view of a front of the glasses of FIG. 1;

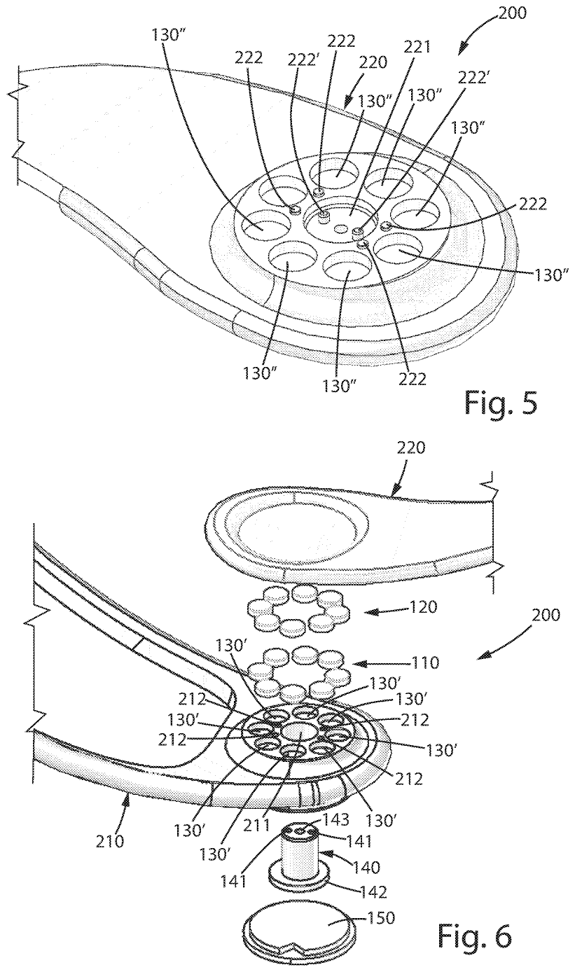

FIG. 5 is a perspective view of a temple of the glasses of FIG. 1;

FIG. 6 is a first exploded perspective view of the glasses of FIG. 1;

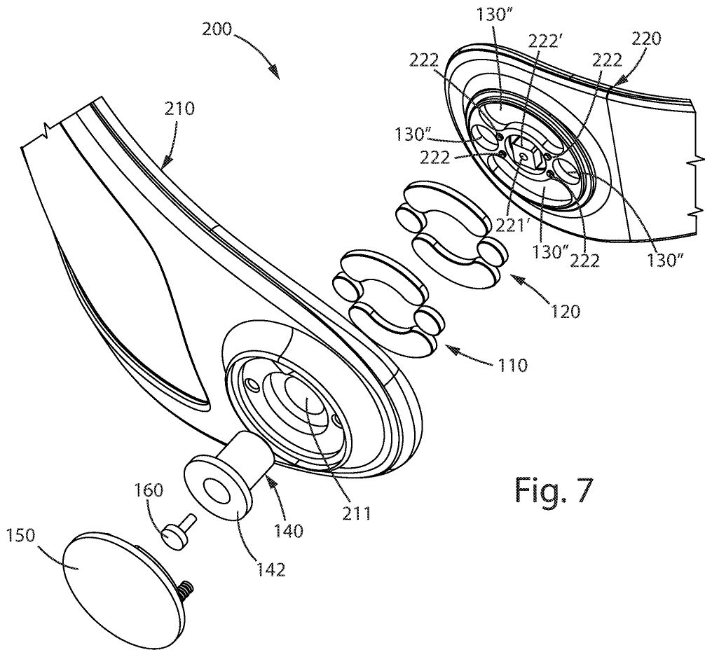

FIG. 7 is a second exploded perspective view of the glasses according to a second embodiment of the present invention;

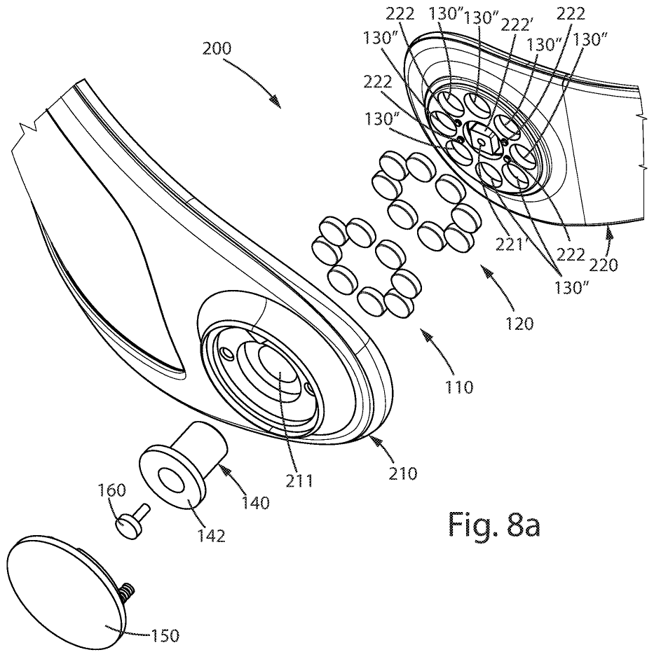

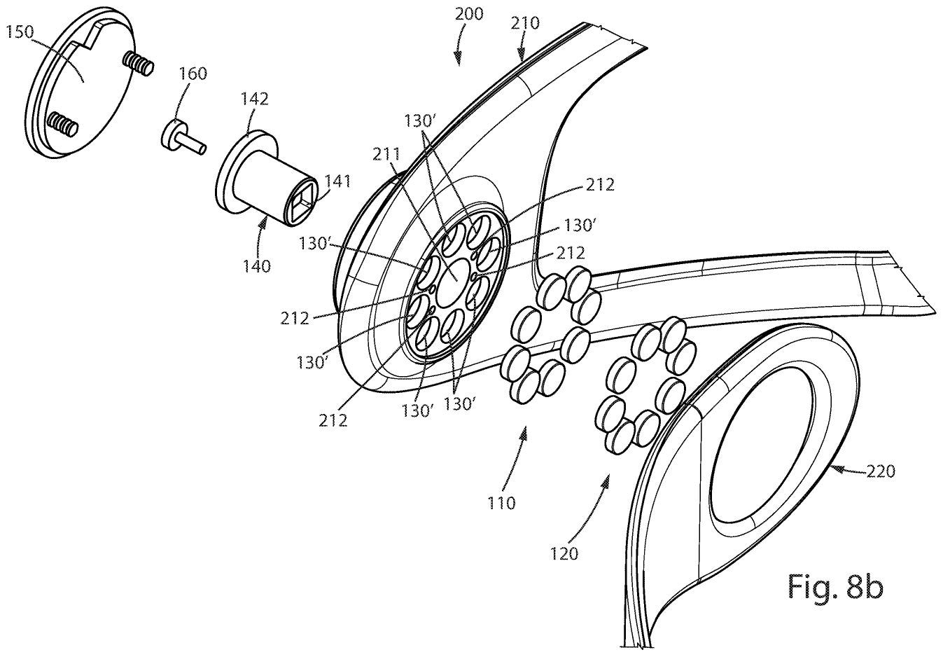

FIG. 8a is a third exploded perspective view of the glasses according to a third embodiment of the present invention;

FIG. 8b is a fourth exploded perspective view of the glasses of FIG. 8a.

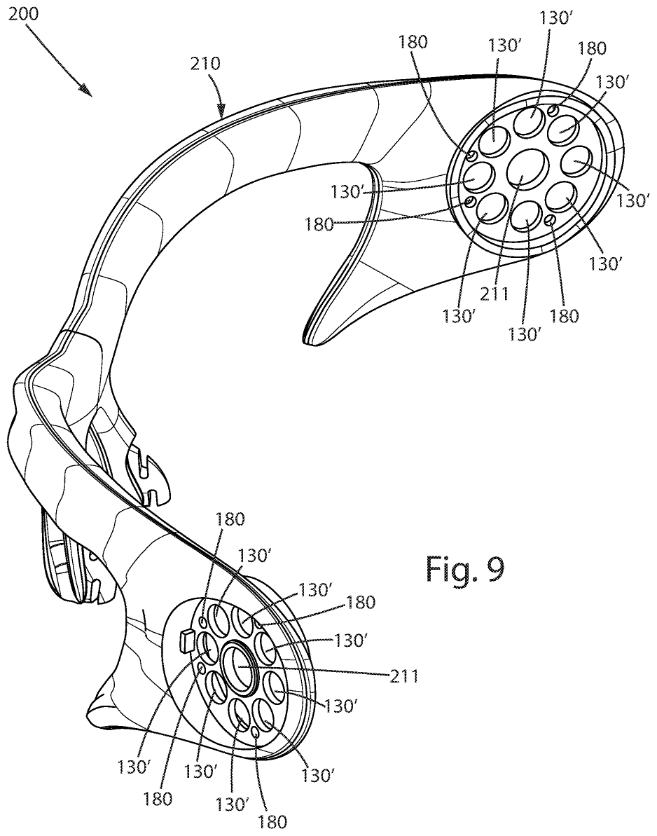

FIG. 9 is a fifth perspective view of a front of the glasses according to a fourth embodiment of the present invention;

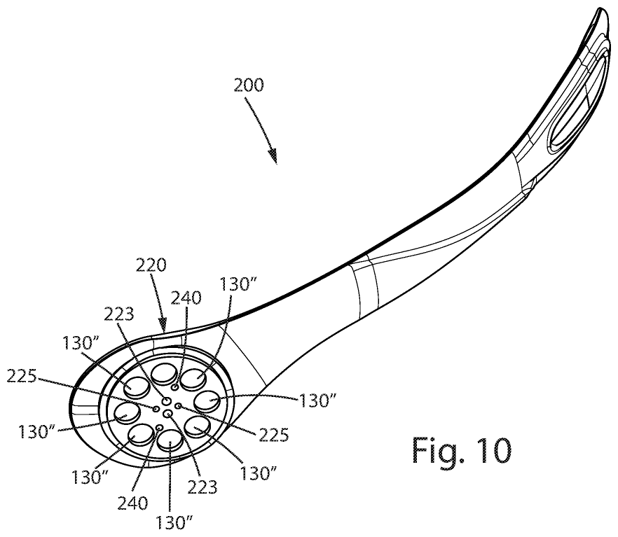

FIG. 10 is a sixth perspective view of a temple of the glasses of FIG. 9;

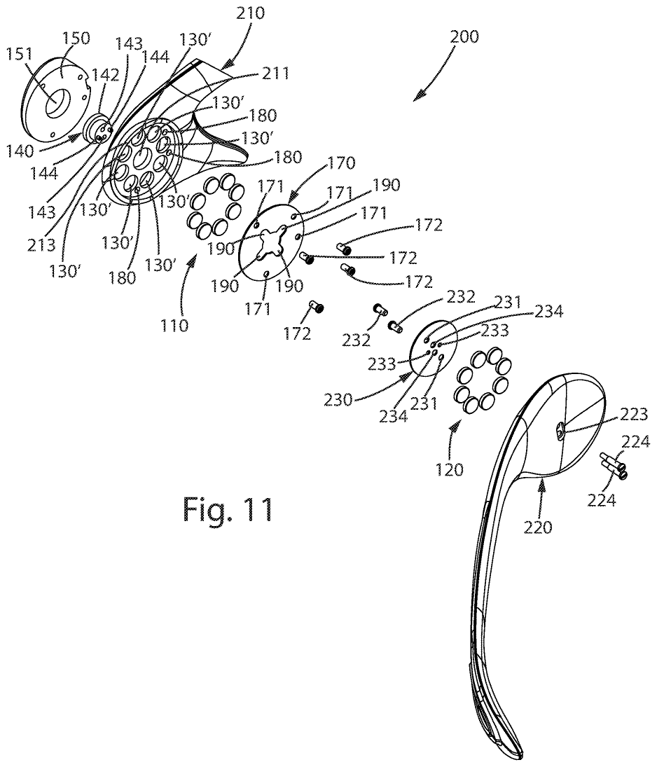

FIG. 11 is a seventh exploded perspective view of the glasses of FIG. 9;

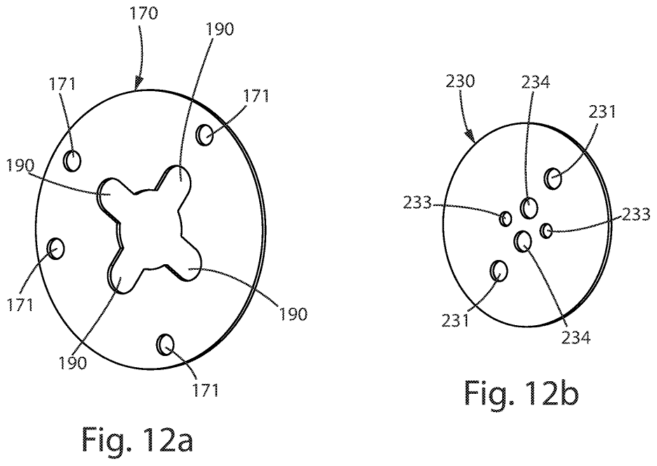

FIGS. 12a, 12b are two perspective views of two fastening plates comprised in the glasses of FIG. 9;

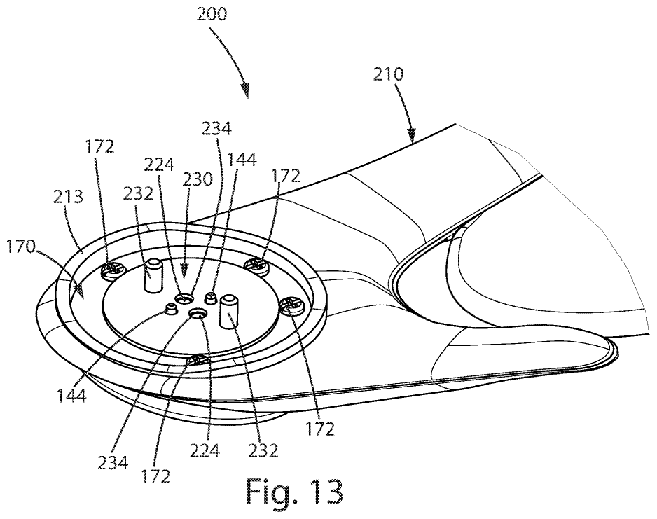

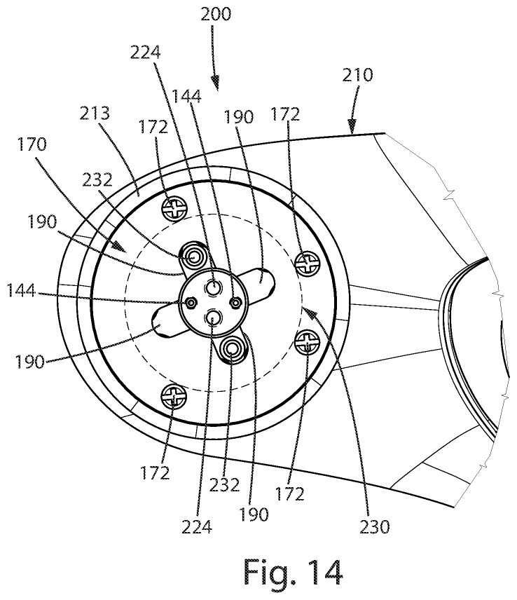

FIGS. 13, 14 are two partial perspective views of the glasses of FIG. 9 from which the temples and the magnets coupled thereto were eliminated for the sake of simplicity.

With reference to the figures, glasses overall denoted by 200 are shown.

Such glasses 200 comprise a frame comprising in turn a front 210 adapted to support two lenses and two temples 220 adapted to allow a user to wear the glasses 200.

The temples 220 are rotatably coupled to the front 210 so as to be able to rotate between a first stable opening position wherein the temples 220 are open and the glasses 200 can be worn by the user and a second stable closing position wherein the temples 220 are closed and the glasses 200 cannot be worn by the user. The rotation of the temples can be made both clockwise and counterclockwise.

Advantageously, the glasses 200 comprise two hinge assemblies overall denoted by 100 by which the temples 220 are rotatably coupled to the front 210.

Each hinge assembly 100 comprises at least four first magnets 110 applied to the front 210.

Such at least four first magnets 110 are spaced apart from each other and arranged so as to describe a circumference.

Furthermore, the hinge assembly 100 also comprises at least four second magnets 120 applied to the respective temple 220 and opposed to the at least four first magnets 110. Such at least four second magnets 120 are spaced apart from each other and arranged so as to describe a circumference.

Each first magnet 110 has a first surface in contact with the front 210 and a second surface opposite to the first. The first and second surfaces have two magnetic polarities opposite to each other. The second surface will be also referred to as a free pole of the first magnet 110 below.

In more detail, the at least four first magnets 110 have a pole in contact with the front 210 and a free pole facing the respective temple 220. Each second magnet 120 has a first surface in contact with the respective temple 220 and a second surface opposite to the first. The first and second surfaces have two magnetic polarities opposite to each other. The first surface will be referred to as a pole of the second magnet 120 below, while the second surface will be also referred to as a free pole of the second magnet 120 below.

In more detail, the at least four second magnets 120 have a pole in contact with the respective temple 220 and a free pole facing the front 210.

Furthermore, the at least four first magnets 110 have free poles at alternating polarities according to any period. Preferably, the period is 180° so as to allow the poles to be coupled only in a condition of open temple and/or closed temple.

Advantageously, with respect to the traditional hinges which have the £ rotation axis of the hinges substantially perpendicular to the plane passing through the nose-ears supporting points, the glasses 200 according to the present invention comprise a hinge assembly 100 which has a rotation axis substantially parallel to such plane.

In a second embodiment illustrated in FIG. 7, the at least four first magnets 110 are in number equal to four; in such case, each first magnet 110 is interposed between magnets which have a free pole of opposite sign to its own. In more detail, a first magnet 110 which has the positive free pole is interposed between magnets 110 which have the negative free pole, while a first magnet 110 which has the negative free pole is interposed between magnets 110 which have the positive free pole.

Furthermore, the at least four second magnets 120 have free poles at alternating polarities according to any period.

Still in the second embodiment, in the case where the at least four first magnets 110 are in number equal to four, the at least four second magnets 120 are also in number equal to four; in such case, each second magnet 120 is interposed between magnets 120 which have a free pole of opposite sign to its own. In more detail, a second magnet 120 which has the positive free pole is interposed between magnets 120 which have the negative free pole, while a second magnet 120 which has the negative free pole is interposed between magnets 120 which have the positive free pole.

In the particular embodiments shown in FIGS. 1-6 and 8a-14, the at least four first magnets 110 and the at least four second magnets 120 are respectively in number equal to eight. In such case, in a preferred embodiment, each first magnet 110 is interposed between a first magnet 110 which has the positive free pole and a first magnet 110 which has the negative free pole; similarly, each second magnet 120 is interposed between a second magnet 120 which has the positive free pole and a second magnet 120 which has the negative free pole.

In another preferred embodiment, the eight first magnets 110 comprise two first main magnets 110 interposed between two series of three first secondary magnets 110 wherein the first secondary magnets 110 have the free pole with polarity equal and opposite to that of the free pole of the first main magnets 110. In such case, the eight second magnets 120 comprise two second main magnets 120 interposed between two series of three second secondary magnets 120 wherein the second secondary magnets 120 have the free pole with polarity equal and opposite to that of the free pole of the second main magnets 120. Furthermore, the second magnets 120 have however the free pole with polarity opposite to that of the opposed first magnets 110 when the hinge assembly 100 is in one of the two stable positions.

In another embodiment, the first magnets 110 are arranged in succession at alternating polarity with each other. In such case, the second magnets 120 are also arranged in succession at alternating polarity with each other. Furthermore, the second magnets 120 have however the free pole with polarity opposite to that of the opposed first magnets 110 when the hinge assembly 100 is in one of the two stable positions.

Preferably, the at least four first magnets 110 and the at least four second magnets 120 can be applied respectively to the front 210 and the respective temple 220 by any fastening device or method, such as for example a glue or a both sides adhesive layer.

Preferably, the at least four first magnets 110 are entirely housed inside first seats 130′ obtained in the front 210 and the at least four second magnets 120 are entirely housed inside second seats 130″ obtained in the temples 220.

In another embodiment, not shown in figures, the at least four first magnets 110 are at least partially housed inside the first seats 130′ obtained in the front 210 and the at least four second magnets 120 are at least partially housed inside the second seats 130″ obtained in the temples 220.

Such first seats 130′ and second seats 130″ can extend in depth respectively in the front 210 and in the respective temple 220 by a section equal to or higher than the thickness of the magnets 110, 120 in length. In such case, in a preferred embodiment, the at least four first magnets 110 do not protrude from a surface of the front 210 and the at least four second magnets 120 do not protrude from a surface of the respective temple 220 but are flush respectively with the front 210 and the respective temple 220.

In a fourth embodiment illustrated in FIGS. 9-14, the magnets 110, 120 are recessed in the respective seats 130′, 130″ of the front 210 and the temples 220 and such seats 130′, 130″ can be at least partially through seats.

Preferably, the first seats 130′ are obtained on a first support body applied to the front 210 and the second seats 130″ are obtained on a second support body applied to the respective temple 220. In such case, the first support body and the second support body are respectively applied to the front 210 and the respective temple 220 by any fastening system, for example by gluing or welding.

In the embodiments illustrated in the attached figures, the front 210 comprises two first through holes 211 extending respectively towards the respective temple 220. Furthermore, the hinge assembly 100 comprises a coupling pin 140 which passes through the respective first through hole 211 and is coupled to the temple 220 so as to create a rotatable coupling between the respective temple 220 and the front 210. In the embodiments illustrated in FIGS. 1-8b, the respective temple 220 comprises a blind hole 221 coaxial to the respective first through hole 211. In such case, the coupling pin 140 which passes through the first through hole 211 and is housed in the blind hole 221 so as to create a rotatable coupling between the respective temple 220 and the front 210. Therefore, the respective temple 220 can rotate around an axis passing through the first through hole 211 and the blind hole 221 when passing from the first stable opening position to the second stable closing position or vice versa.

Advantageously, the hinge assembly 100 comprises a covering element 150 applied to the front 210 so as to hide from outside view the coupling pin 140.

Preferably, the coupling pin 140 can be created in the form of a screw having a threaded end portion of the stem and a non-threaded cylindrical intermediate portion. In such case, the end portion of the stem is coupled with corresponding threaded portions created in the blind hole 221, while the cylindrical intermediate portion is comprised within the respective first through hole 211. In this way, when the respective temple 220 passes from the first stable opening position to the second stable closing position or vice versa, the respective temple 220 rotates integrally together with the coupling pin 140 with respect to the front 210.

Preferably, the coupling pin 140 is provided with at least one recess 143.

Furthermore, the hinge assembly 100 can comprise at least one coupling element 160 inserted in such at least one recess 143.

In the embodiments illustrated in FIGS. 1-8b, the coupling pin 140 is a blind bush and such at least one recess 143 is obtained on a bottom wall of such blind bush. In such case, on the bottom wall of the blind hole 221, there is a further blind hole 221′ having a smaller diameter than the blind hole 221 which can be threaded or non-threaded. In such case, the at least one coupling element 160, such as for example a screw (such as for example that illustrated in FIGS. 7, 8a, 8b) also provided with threaded portions, is housed inside the at least one recess 143 and is engaged in the further blind hole 221′. For example, the threaded portions of the at least one coupling element 160 are arranged at the threaded portions of the further blind hole 221′ such that the at least one coupling element 160 abuts with a wall of the at least one recess 143. Thereby, when the temple 220 passes from the first stable opening position to the second stable closing position or vice versa, the temple 220 can rotate integrally with the coupling pin 140 with respect to the front 210. Therefore, in such case, the coupling pin 140 guides in rotation the respective temple 220.

In the embodiments illustrated in FIGS. 1-8b, the temples 220 comprise a plurality of first protrusions 222, 222′ extending towards the front 210; in such case, the front 210 and the coupling pin 140 comprise a plurality of respective first receiving seats 212, 141, facing the respective temple 220 and adapted to receive such first protrusions 222, 222′. Preferably, when the respective temple 220 is in the first stable opening position and/or in the second stable closing position, the first protrusions 222, 222′ are housed in the respective first receiving seats 212, 141, while when the respective temple 220 is in an intermediate position between the first stable opening position and the second stable closing position, the first protrusions 222, 222′ are not housed in the respective first receiving seats 212, 141 but respectively contact a surface of the front 210 and the coupling pin 140 on which the first receiving seats 212, 141 are obtained.

Particularly, in the first embodiment shown in FIGS. 1-6, the temples 220 comprise a plurality of first protrusions 222 around the blind hole 221 and the further blind hole 221′ is created on the bottom surface of the blind hole 221.

Conversely, in the embodiments of FIGS. 7, 8a and 8b the temples 220 comprise a plurality of first protrusions 222 around the blind hole 221 and a further first protrusion 222′ extending from the bottom wall of the blind hole 221 and has the further blind hole 221′ at its top.

In the fourth embodiment illustrated in FIGS. 9-14, the hinge assembly 100 comprises at least one respective fastening element 224 which integrally couples the respective temple 220 to the coupling pin 140. In more detail, the respective temple 220 comprises at least one second through hole 223 and the at least one fastening element 224 passes through such at least one second through hole 223 and the first through hole 211 and is engaged in the at least one recess 143 so as to integrally couple the respective temple 220 to the coupling pin 140.

Thereby, the respective temple 220 can rotate integrally with the coupling pin 140 with respect to the front 210.

For example, the second through holes 223, the recesses 143 and the fastening elements 224 are in number equal to two.

Still in the fourth embodiment illustrated in FIGS. 9-14, the coupling pin 140 comprises a plurality of second protrusions 144 which protrude towards the respective temple 220; in such case, the respective temple 220 comprises a respective plurality of second receiving seats 225 which accommodate the second protrusions 144. In this case, the coupling pin 140 is integral in rotation with the respective temple 220 since the second protrusions 144 are inserted in the second receiving seats 225 even when the hinge assembly 100 is not in the first stable opening position or in the second stable closing position.

Still in the fourth embodiment, the hinge assembly 100 comprises a first fastening plate 170 coupled with the front 210 at the first magnets 110 and a second fastening plate 230 coupled with a respective temple 220 at the second magnets 120 so as to prevent the magnets 110, 120 from escaping the respective first seats 130′ and second seats 130″.

In other words, the first fastening plate 170 and the second fastening plate 230 face each other; in such case the first magnets 110 are opposed to the second magnets 120 by interposing of the first fastening plate 170 and the second fastening plate 230.

In more detail, the front 210 and the temples 220 have respective fastening seats 180, 240; in such case, the first fastening plate 170 has first fastening through holes 171 arranged at such fastening seats 180 of the front 210, while the second fastening plate 230 has second fastening through holes 231 arranged at the fastening seats 240 of the respective temple 220. The first fastening plate 170 is integrally fastened to the front 210 thanks to first engaging elements 172, while the second fastening plate 230 is integrally fastened to the respective temple 220 thanks to second engaging elements 232.

In more detail, the first engaging elements 172 pass through the first fastening through holes 171 and are engaged in the fastening seats 180 of the front 210, while the second engaging elements 232 pass through the second fastening through holes 231 and are engaged in the fastening seats 240 of the temple 220.

For example, the engaging elements 172, 232 can be created in the form of a screw having a first abutting portion which abuts on the respective fastening plate and a second threaded portion having a smaller diameter than the first abutting portion which is coupled to corresponding threaded portions created in the fastening seats 180, 240. Furthermore, the first engaging elements 172 are coupled to the first fastening plate 170 so as to result radially external to the second fastening plate 230.

Furthermore, the first fastening plate 170 has two identification seats 190 which identify the first stable opening position and the second stable closing position in collaboration with the second engaging elements 232 coupled with the second fastening plate 230. Indeed, as can be observed in FIG. 14, when the hinge assembly 100 is assembled and assumes one of the two stable positions cited above, the second engaging elements 232 are at least partially housed in one of the two identification seats 190.

Preferably, said first fastening plate 170 and second fastening plate 230 are made of non-magnetic material, such as for example plastic non-magnetic metal, to prevent undesired deformations of the coupling magnetic field.

For example, in the embodiment of FIG. 14 the two identification seats 190 can be through seats and cross each other creating a through opening in the form of a cross.

Preferably, the front 210 has a perimetral confining edge 213 of the hinging area, where such perimetral confining edge 213 is cam-shaped so as to force the temple 220 away from the front 210 when the hinge assembly 100 is moved from one stable position to another, and to allow the approach between the temple 220 and the front 210 when the hinge assembly 100 assumes one of the two stable positions.

Furthermore, the second fastening plate 230 has a plurality of first through openings 233 and at least one second through opening 234 respectively passed through by the second protrusions 144 and the at least one fastening element 224.

Preferably, the coupling pin 140 comprises a flanged cover 142. Such flanged cover 142 has a greater diameter than the diameter of the coupling pin 140.

Furthermore, in the fourth embodiment, the covering element 150 can have an engaging seat 151 for the coupling pin 140.

Advantageously, when the respective temple 220 is in the first stable opening position and/or in the second stable closing position, the free poles of the at least four first magnets 110 and of the respective at least four opposed second magnets 120 have opposite polarities so as to attract each other.

In more detail, the at least four first magnets 110 are aligned with the at least four second magnets 120 such that the positive free poles of the ones are placed at the negative free poles of the others when the respective temple 220 is in the first stable opening position and/or in the second stable closing position.

Alignment or alignment condition means that all the free poles of the first magnets 110 are placed at the free poles of opposite sign of the opposed second magnets 120.

In more detail, the positive free poles of the at least four first magnets 110 are placed at the negative free poles of the at least four opposed second magnets 120, and the negative free poles of the at least four first magnets 110 are placed at the positive free poles of the at least four opposed second magnets 120.

As is known, the free poles of opposite sign tend to attract each other exerting an attractive force which tends to bring the magnets 110, 120 closer until minimizing the distance between such free poles. In the glasses 200 the first magnets 110 and the second magnets 120 are stably applied respectively to the front 210 and the respective temple 220; in other words, the first magnets 110 and the second magnets 120 cannot be detached respectively from the front 210 and the respective temple 220 under the effect of the attractive force. Furthermore, when the respective temple 220 is in the first stable opening position or in the second stable closing position, each free pole of the first magnets 110 is placed at a minimum distance from a free pole of opposite sign of the opposed second magnets 120. Therefore, the free poles of opposite sign are attracted by each other and at the same time cannot further approach; therefore, the attractive force prevents the respective temple 220 from spontaneously rotating with respect to the front 210, for example under the effect of the weight of the temple 220 itself, as a rotation of the temple 220 would result in an increase of the minimum distance between the free poles of opposite sign.

Therefore, in this way, the respective temple 220 is kept in the first stable opening position or in the second stable closing position.

In the embodiments illustrated in the attached figures, in the case where the at least four first magnets 110 and the at least four second magnets 120 are respectively in number equal to four or eight, the stable positions are two at an angular distance of 180° to each other. Such angular distance of 180° depends on the arrangement of the first magnets 110 and the second magnets 120 and on a number of sign alternations of the free poles in series of the first magnets 110 or the second magnets 120.

Number of sign alternations means how many times a free pole of the first magnets 110 or the second magnets 120 is succeeded by a free pole of opposite sign to its own respectively of the first magnets 110 or the second magnets 120.

The alignment condition of the free poles coincides with a stable position of the respective temple 220, in more detail with the first stable opening position or the second stable closing position.

When the respective temple 220 passes from the first stable opening position to the second stable closing position or vice versa, the free poles of opposite sign are misaligned.

Misalignment or misalignment condition means that at least one free pole of the first magnets 110 is no longer placed at a free pole of opposite sign of the opposed second magnets 120.

When the free poles are in the misalignment condition, at least one free pole is no longer placed at the minimum distance from a free pole of opposite sign; therefore, as described above, the attractive force between the poles of opposite sign tends to bring the first magnets 110 closer to the second magnets 120 and vice versa until minimizing the distance between the free poles of opposite sign. In this way, when the free poles are in the misalignment condition, the respective temple 220, if released by the user, tends to rotate and to return to the first stable opening position or to the second stable closing position wherein the free poles of opposite sign are at the minimum distance to each other.

Furthermore, starting from the alignment condition, when an angular excursion of the respective temple 220 increases up to a certain limit value, the number of misaligned free poles rises.

Such limit value depends on the distance between a magnet 110, 120 and the next one in series.

Furthermore, continuing the above-described angular excursion, the free poles begin to align again when such angular excursion of the respective temple 220 exceeds such limit value; at this point, if the respective temple 220 performs a new angular excursion still equal to the limit value, the free poles will be again misaligned and so on. This behaviour is due to the fact that the at least four first magnets 110 and the at least four second magnets 120 respectively describe a circumference, or a closed line.

Therefore, starting from the alignment condition or from a complete misalignment condition, for each angular excursion of the respective temple 220 equal to the limit value, the free poles move respectively to the alignment or complete misalignment condition.

Complete misalignment or complete misalignment condition means that each free pole of the first magnets 110 is not placed at a free pole of opposite sign of the opposed second magnets 120.

In more detail, if the respective temple 220 is in the first stable opening position, for each angular excursion equal to the limit value it passes first to the complete misalignment condition, then to the alignment condition represented by the second stable closing position, then again to the complete misalignment condition and then returns to the first stable opening position; if the respective temple is in the second stable closing position, for each angular excursion equal to the limit value it passes to the complete misalignment condition, then to the complete alignment condition represented by the first stable opening position, then again to the complete misalignment condition and then returns to the second stable closing position.

Preferably, the first magnets 110 are equally spaced from each other and the second magnets 120 are equally spaced from each other.

Preferably, the limit value is 90°.

In the embodiments shown in the attached figures, starting from the complete misalignment or alignment condition, for each angular excursion of the respective temple 220 equal to the angular distance of 180°, the free poles pass respectively again to the complete misalignment or alignment condition. In such case, for each angular excursion equal to the angular distance of 180° of the respective temple 220, the latter passes from the first stable opening position to the second stable closing position or vice versa.

In the case where the at least four first magnets 110 and the at least four second magnets are in number equal to eight, if the respective temple 220, starting from the first stable opening position or from the second stable closing position, performs an angular excursion equal to a threshold value lower than the limit value, only a free pole of the pair of adjacent free poles of equal sign is in the misalignment condition. At this point, the complete misalignment condition is achieved when the respective temple 220 performs a further angular excursion equal to the difference between the limit value and the threshold value.

Preferably, the threshold value is 45°.

Furthermore, if the user releases the respective temple 220 when the free poles are in the misalignment condition, such temple 220 returns to the first stable opening position or to the second stable closing position. In more detail, if the user releases the temple 220 when it is in an angular neighbourhood of width equal to the angular distance 180° with respect to the first stable opening position, the temple 220 returns to such first stable opening position; if the user releases the temple 220 when it is in an angular neighbourhood of width equal to the angular distance of 180° with respect to the second stable closing position, the temple 220 returns to such second stable closing position. This behaviour is due to the fact that the respective temple 220 rotates to return to the first stable opening position or to the second stable closing position under the effect of the attractive force as described above.

In the fourth embodiment, when the hinge assembly 100 passes from one of the two stable positions to the other, the first magnets 110 are forced to be opposed to the second magnets 120 having the same polarity; thereby, a magnetic repulsion force which moves the temple 220 away from the front 210 is developed. Thus, the second engaging elements 232 escape the identification seat 190 corresponding to the stable starting position and then are brought at the identification seat 190 of the stable finishing position wherein the first magnets 110 are opposed to the second magnets 120 of opposite polarity.

In the case where there is also the cam-shaped perimetral confining edge 213, moving the front 210 away from the temple 220 occurs due to the combined effect of the magnetic repulsion force and the thrust determined by the profile of the perimetral confining edge 213.

The features of the glasses object of the present invention are clear from the made description, as well as the related advantages are clear.

It is clear, finally, that the glasses thus conceived are susceptible of a number of modifications and variants, all falling within the invention; furthermore, all the details are replaceable by technically equivalent elements. In practice, the used materials, as well as the size, can be any depending on the technical requirements.

1. Glasses comprising:
a front and two temples rotatably coupled to said front to rotate between a first stable opening position and a second stable closing position; and
two hinge assemblies by which said temples are rotatably coupled to said front, each of said hinge assemblies comprising:
at least four first magnets applied to said front, said at least four first magnets being spaced apart from each other and arranged so as to describe a circumference, said at least four first magnets having free poles at alternating polarities according to any period, and
at least four second magnets applied to the respective temple, opposed to said at least four first magnets, said at least four second magnets being spaced apart from each other and arranged so as to describe a circumference, said at least four second magnets having free poles at alternating polarities according to any period,
wherein when the respective temple is in the first stable opening position and/or in the second stable closing position the free poles of said at least four first magnets and of the respective at least four opposed second magnets have opposite polarities so as to attract each other.

2. The glasses according to claim 1, wherein said at least four first magnets and said at least four second magnets are respectively in number equal to eight, each first magnet being interposed between a first magnet which has the positive free pole and a first magnet which has the negative free pole, each second magnet being interposed between a second magnet which has the positive free pole and a second magnet which has the negative free pole.

3. The glasses according to claim 1,
wherein said at least four first magnets and said at least four second magnets are respectively in number equal to eight, said eight first magnets comprise two first main magnets interposed between two series of three first secondary magnets,
wherein the first secondary magnets have the free pole with polarity equal and opposite to that of the free pole of the first main magnets, said eight second magnets comprise two second main magnets interposed between two series of three second secondary magnets, and
wherein the second secondary magnets have the free pole with polarity equal and opposite to that of the free pole of the second main magnets.

4. The glasses according to claim 1, wherein said at least four first magnets are at least partially housed inside first seats obtained in the front and said at least four second magnets are at least partially housed inside second seats obtained in the temples.

5. The glasses according to claim 1, wherein said at least four first magnets are entirely housed inside first seats obtained in the front and said at least four second magnets are entirely housed inside second seats obtained in the temples.

6. The glasses according to claim 4, wherein said first seats are obtained on a first support body applied to said front and said second seats are obtained on a second support body applied to the respective temple.

7. The glasses according to claim 1, wherein said front comprises two first through holes extending respectively towards the respective temple, said hinge assembly comprising a coupling pin which passes through the respective first through hole and is coupled to the temple so as to create a rotatable coupling between the respective temple and the front.

8. The glasses according to claim 7, wherein said temples comprise a plurality of first protrusions extending towards the front, said front and said coupling pin comprising a plurality of respective first receiving seats facing the respective temple, said first protrusions being housed in the respective first receiving seats when the respective temple is in the first stable opening position and/or in the second stable closing position.

9. The glasses according to claim 7, wherein said hinge assembly comprises a first fastening plate coupled with said front at said first magnets and a second fastening plate coupled with a respective temple at said second magnets so as to prevent said magnets from escaping the respective first seats and second seats, said hinge assembly comprising at least one respective fastening element which integrally couples the respective temple to the coupling pin, said first fastening plate being integrally fastened to the front thanks to first engaging elements, said second fastening plate being integrally fastened to the respective temple thanks to second engaging elements, said first fastening plate having two identification seats which identify the first stable opening position and the second stable closing position in collaboration with said second engaging elements coupled with said second fastening plate.

10. The glasses according to claim 9, wherein said coupling pin comprises a plurality of second protrusions which protrude towards the respective temple, the respective temple comprising a respective plurality of second receiving seats which accommodate the second protrusions.

11. The glasses according to claim 9, wherein said front has a perimetral confining edge of the hinging area, where such perimetral confining edge is cam-shaped so as to force the temple away from the front when the hinge assembly is moved from one stable position to another, and to allow the approach between the temple and the front when the hinge assembly assumes one of the two stable positions.
